(19) United States
(12) Patent Application Publication
(10) Pub. No.: US 2024/0048650 A1
(43) Pub. Date: Feb. 8, 2024

(54) Frame Tracker Device

(71) Applicants: Tishrea Johnson, Nassau (BS); Rodney Johnson, Nassau (BS)

(72) Inventors: Tishrea Johnson, Nassau (BS); Rodney Johnson, Nassau (BS)

(21) Appl. No.: 18/363,836

(22) Filed: Aug. 2, 2023

Related U.S. Application Data
(60) Provisional application No. 63/395,092, filed on Aug. 4, 2022.

(51) Int. Cl. H04M 1/72412; H04M 1/72457; H04M 1/72406; G02C 11/00

(52) U.S. Cl. CPC H04M 1/72412; H04M 1/72457; H04M 1/72406; G02C 11/10

(57) ABSTRACT

The present invention relates to a novel frame tracker device. The device is an improved eyeglass or sunglass frame with an integrated tracking unit. The frame tracker device comprises an integrated tracking unit, such as a GPS device, which is used to track the frames via a smartphone application. Users wirelessly pair their eyeglass frames with the smartphone application downloaded on their smartphone to view the eyeglass frame's location on a digital map. The frame tracker device also comprises an alarm that can be triggered by the smartphone application to produce an audible sound from the frames so that the frames can be easily found.

### CROSS-REFERENCE TO RELATED APPLICATION

The present application claims priority to, and the benefit of, U.S. Provisional Application No. 63/395,092, which was filed on Aug. 4, 2022, and is incorporated herein by reference in its entirety.

### FIELD OF THE INVENTION

The present invention relates generally to the field of frame tracker devices. More specifically, the present invention relates to an identification system for glasses designed to identify their location on a digital smartphone application map. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in frame tracker devices. Generally, people who wear glasses for certain activities may take them off and set them down when they are not being used. Some people may also forget where they last put their glasses, or the frames can get knocked off a table or countertop surface. Additionally, the glasses may drop out of sight and be difficult to find. Furthermore, people who take off their glasses in public places may forget to pick them back up and permanently lose them. Also, purchasing replacement frames and lenses can be incredibly expensive.

Many people wear eyeglasses in order to see properly if their eyesight is poor. Eyeglasses are devices consisting of lenses which are mounted in a frame and worn on the bridge of the nose so that the lenses are placed in front of a viewer's eyes. The eyeglass lenses bend the rays of light which pass through in order to focus a user's vision. Due to the compact size of most eyeglasses, it is extremely common for them to become lost or misplaced. When glasses are missing for a short time, a user may be unable to perform important activities such as driving or reading. In some instances, eyeglasses are lost, never found, and must be replaced. An effective solution is desired.

Accordingly, a need remains for a device that aids a user in locating their lost or misplaced glasses. The described device discloses monitoring the location of a pair of glasses via a software application on a smartphone. Users link an integrated tracking unit within the eyeglass frames with their smartphone, which then conveniently tracks the frame's location on a map displayed on their smartphone.

Therefore, there exists a long-felt need in the art for a frame tracker device that provides users with an identification system for eyeglasses designed to identify the eyeglass' location on a digital smartphone application map. There is also a long-felt need in the art for a frame tracker device that utilizes an embedded geolocation tracker within the eyeglass frame to wirelessly transmit location data to the smartphone application if the frames are lost. Further, there is a long-felt need in the art for a frame tracker device that features a speaker that can sound an audible alert when activated from the smartphone application to help the user identify where his or her eyeglasses are located. Moreover, there is a long-felt need in the art for a device that prevents people from dropping or misplacing their glasses and being forced to purchase an expensive replacement. Further, there is a long-felt need in the art for a frame tracker device that utilizes a small marker that is placed where the eyeglasses are located for the user to identify the general vicinity to locate their eyeglasses. Finally, there is a long-felt need in the art for a frame tracker device that can be utilized with a large variety of eyeglasses.

The subject matter disclosed and claimed herein, in one embodiment thereof, comprises a frame tracker device. The device is an improved eyeglass or sunglass frame with an integrated tracking unit. The frame tracker device comprises an integrated tracking unit, such as a GPS device, which is used to track the frames via a smartphone application. Users wirelessly pair their eyeglass frames with the smartphone application downloaded on their smartphone to view the eyeglass frame's location on a digital map. The frame tracker device also comprises an alarm that can be triggered by the smartphone application to produce an audible sound from the frames so that the frames can be easily found.

Furthermore, the frame tracker device is designed such that the eyeglass frames are still lightweight, despite being equipped with wiring and components associated with the integrated tracking unit. Further, the frame tracker device can utilize the smartphone application to place a small marker or drop a pin where the eyeglass frames are located, allowing the user to identify the general vicinity in which to locate their eyeglass frames. Users would link the integrated tracking unit with their smartphone to conveniently track the eyeglass frame's location on the map on their smartphone. The tracking information along with the triggering of the audible alarm/alert allows a user to conveniently and quickly locate their eyeglasses to prevent a permanent loss.

In this manner, the frame tracker device of the present invention accomplishes all of the foregoing objectives and provides users with a device that provides location information for a user's eyeglass frames. The device also comprises an audible alarm to alert a user. The device is generally linked to a smartphone or other smart device.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a frame tracker device. The device is an improved eyeglass or sunglass frame with an integrated tracking unit. The frame tracker device comprises an integrated tracking unit, such as a GPS device, which is used to track the frames via a smartphone application. Users wirelessly pair their eyeglass frames with the smartphone application downloaded on their smartphone to view the eyeglass frame's location on a digital map.

As discussed above, embodiments of the present disclosure relate to a frame tracker device and more particularly, to an eyeglass tracking system and method used to improve locating of misplaced eyeglasses.

Generally speaking, the frame tracker device provides a tracking system for a pair of eyeglass frames. The eyeglass frames can be any suitable shape and size of eyeglass and/or sunglass frames, as is conventionally known in the art. Typically, the eyeglass frames comprise an eye receptacle component with lenses and two arm components which secure to either side of the eye receptacle and rest behind a user's ear during wear. Further, the device is comprised of an embedded or integrated tracking unit that may be placed anywhere within the eyeglass frame, such as in the nose frame or temple frame, depending on the needs and/or wants of a user. Furthermore, the frame tracker device is designed such that the eyeglass frames are still lightweight, despite being equipped with wiring and components associated with the integrated tracking unit.

Additionally, the eyeglass frame is preferably an amorphous, amber-to-transparent thermoplastic. The material of the eyeglass frame allows the integrated tracking unit to send transmissions at greater distances, resulting in better connections and more accurate and precise information. The integrated tracking unit works in tandem with a mobile or smartphone computing device application to allow the user to see the location of the eyeglasses on demand. The smartphone application and integrated tracking unit/transmitter may communicate by way of an IEEE 802.15 standard network, GPS, etc., or other technology.

In one embodiment, any suitable mobile or smartphone computing device can be used, such as phones, tablets, smartwatches, etc., or any other suitable smart device as is known in the art. Further, the smartphone device is able to continuously store tracking information for the eyeglass frames. Additionally, this concept may also be applied to sunglass frames.

In certain embodiments, the integrated tracking unit/transmitter may be removably sealed within a pair of eyeglass frames. Thus, the integrated tracking unit/transmitter may be removed and applied to another set of eyeglass frames in a sealed condition, as needed and/or desired. Thus, a user can utilize the integrated tracking unit for location tracking with any pair of eyeglasses or sunglasses that they wish.

In one embodiment, the frame tracker device may be beneficial for use by a user to locate missing eyeglasses. Specifically, the frame tracker device may include an eyeglass frame with a first concealed low-power, low-duty, low data-rate IEEE 802.15.4/GPS tracking chip/transceiver attached or integrated to the eyeglass frame, preferably in a concealed manner, and configured to transmit a wireless signal, and a mobile or smartphone communications device comprising a processor to execute instructions retrieved from a memory, a second low-power, low-duty, low data-rate IEEE 802.15.4/GPS tracking chip/transceiver configured to receive the wireless signal, and a display device.

The first concealed low-power, low-duty, low data-rate IEEE 802.15.4/GPS tracking chip/transceiver is configured to transmit the wireless signal autonomously for months without recharging. When executed, the instructions control the processor to process the wireless signal transmitted/received by the first concealed low-power, low-duty, low data-rate IEEE 802.15.4/GPS tracking chip/transceiver and second low-power, low-duty, low data-rate IEEE 802.15.4/GPS tracking chip/transceiver to create a navigational display on the display device, and to cause electronic information determined from the wireless signal by the processor to indicate a geographic location of the eyeglass assembly on the navigational display.

In one embodiment, the frame tracker device utilizes the smartphone application to place a small marker or drops a pin where the eyeglass frames are located, allowing the user to identify the general vicinity in which to locate their eyeglass frames.

In one embodiment, the first concealed low-power, low-duty, low data-rate IEEE 802.15.4/GPS transceiver which is integrated into and concealed by the eyeglass frame comprises a power source and an antenna. The first concealed low-power, low-duty, low data-rate IEEE 802.15.4/GPS transceiver continuously transmits electronic location information indicative of geographic location of the eyeglass frames to the smartphone device via the power source and antenna. Specifically, the electronic location information determined from the wireless signal by the processor indicates a relative geographic location on the navigational display of the smartphone. Further, the electronic location information determined from the wireless signal by the processor indicates an absolute or relative geographic location on the navigational display.

In one embodiment, the frame tracker device further comprises a graphical user interface generated by the instructions of the software application; the graphical user interface instructs a user in the direction that indicates the location of the eyeglass frames. The eyeglass frames may also include a global positioning system transceiver, a radio frequency identification tag transponder, a BLUETOOTH transceiver, a ZigBee transceiver, or an ultra-wideband transceiver, etc., for transmitting signals.

In one embodiment, the electronic communication device (i.e., smartphone) of the frame tracker device and/or the integrated tracking unit comprises a sound generating device, which generates an audible alarm or alert. Thus, the eyeglasses may also send an alert (audible or otherwise) to the mobile or smartphone device when the user is a preset distance from their glasses. Further, the electronic location information determined from the wireless signal controls the sound generating device to produce a sound having a volume and frequency that varies with a distance between the eyeglass frame and the electronic communication device (i.e., smartphone). Thus, the audible alarm/alert of the frame tracker device can be triggered by the smartphone application to produce an audible sound from the frames and/or from the smartphone device so that the frames can be easily found. Accordingly, the mobile wireless communications device is wirelessly coupled to the first concealed low-power, low-duty, low data-rate IEEE 802.15.4/GPS transceiver of the eyeglass frame. The processor is then configured to receive a signal from the second low-power, low-duty, low data-rate IEEE 802.15.4/GPS transceiver of the smartphone device. The signal indicates a direction toward the eyeglass frame relative to the mobile wireless communications device.

In one embodiment, the eyeglass frame may also include an IEEE network standard 802.15 transceiver, an IEEE network standard 802.15.4 transceiver, an IEEE network standard 802.15.4a transceiver, an IEEE network standard 802.11 transceiver, and/or an IEEE network standard 802.16 transceiver, further comprising a battery electrically connected to the transceiver. The integrated tracking unit of the eyeglass frame may also be configured to stay charged for longer periods of time and use less power in comparison to traditional BLUETOOTH technology which is desirable.

Accordingly, in use, users would link the integrated tracking unit with their smartphone to conveniently track the eyeglass frame's location on a map on their smartphone. The tracking information, along with the triggering of the audible alarm/alert, allows a user to conveniently and quickly locate their eyeglasses for retrieval to prevent a permanent loss.

According to one embodiment, the frame tracker device may be arranged as a kit. In particular, the frame tracker device may further include a set of instructions. The instructions may detail functional relationships in relation to the structure of the frame tracker device (such that the device can be used, maintained, or the like, in a preferred manner).

In yet another embodiment, the frame tracker device comprises a plurality of indicia.

In yet another embodiment, a method of tracking a user's eyeglass frames to identify location on a smartphone is disclosed. The method includes the steps of providing a frame tracker device comprising an integrated tracking unit which pairs with a smartphone application. The method also comprises wirelessly pairing the eyeglass frames with the smartphone application. Further, the method comprises utilizing the smartphone application to identify the location of the eyeglass frames. Finally, the method comprises sounding the audible alarm to further signal the location of the eyeglass frames.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of one embodiment of the frame tracker device of the present invention showing how the eyeglass frames are integrated with an integration tracking unit, such as a GPS tracking chip, in accordance with the disclosed architecture;

FIG. 2 illustrates a front perspective view of one embodiment of the frame tracker device of the present invention showing the integration tracking unit wirelessly communicating with a software application installed on a smartphone in accordance with the disclosed architecture;

FIG. 3 illustrates a front perspective view of one embodiment of the frame tracker device of the present invention showing the smartphone application in use to locate the eyeglass frames in accordance with the disclosed architecture;

FIG. 4 illustrates a front perspective view of one embodiment of the frame tracker device of the present invention showing the eyeglass frames transmitting location information to the application and sounding an audible alarm in accordance with the disclosed architecture;

FIG. 5 illustrates a front perspective view of one embodiment of the frame tracker device of the present invention showing how the eyeglass frames are easily located by a user in accordance with the disclosed architecture; and

FIG. 6 illustrates a flowchart showing the method of tracking a user's eyeglass frames to identify location on a smartphone in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a frame tracker device that provides users with an identification system for eyeglasses designed to identify the eyeglass' location on a digital smartphone application map. There is also a long-felt need in the art for a frame tracker device that utilizes an embedded geolocation tracker within the eyeglass frame to wirelessly transmit location data to the smartphone application, if the frames are lost. Further, there is a long-felt need in the art for a frame tracker device that features a speaker that can sound an audible alert when activated from the smartphone application to help the user identify where his or her eyeglasses are located. Moreover, there is a long-felt need in the art for a device that prevents people from dropping or misplacing their glasses and being forced to purchase an expensive replacement. Further, there is a long-felt need in the art for a frame tracker device that utilizes a small marker that is placed where the eyeglasses are located for the user to identify the general vicinity to locate their eyeglasses. Finally, there is a long-felt need in the art for a frame tracker device that can be utilized with a large variety of eyeglasses.

The present invention, in one exemplary embodiment, is a novel frame tracker device. The device is an improved eyeglass or sunglass frame with an integrated tracking unit. The frame tracker device comprises an integrated tracking unit, such as a GPS device, which is used to track the frames via a smartphone application. Users wirelessly pair their eyeglass frames with the smartphone application downloaded on their smartphone to view the eyeglass frame's location on a digital map. The frame tracker device also comprises an alarm that can be triggered by the smartphone application to produce an audible sound from the frames so that the frames can be easily found. The present invention also includes a novel method of tracking a user's eyeglass frames to identify the location on a smartphone. The method includes the steps of providing a frame tracker device comprising an integrated tracking unit which pairs with a smartphone application. The method also comprises wirelessly pairing the eyeglass frames with the smartphone application. Further, the method comprises utilizing the smartphone application to identify the location of the eyeglass frames. Finally, the method comprises sounding the audible alarm to further signal the location of the eyeglass frames.

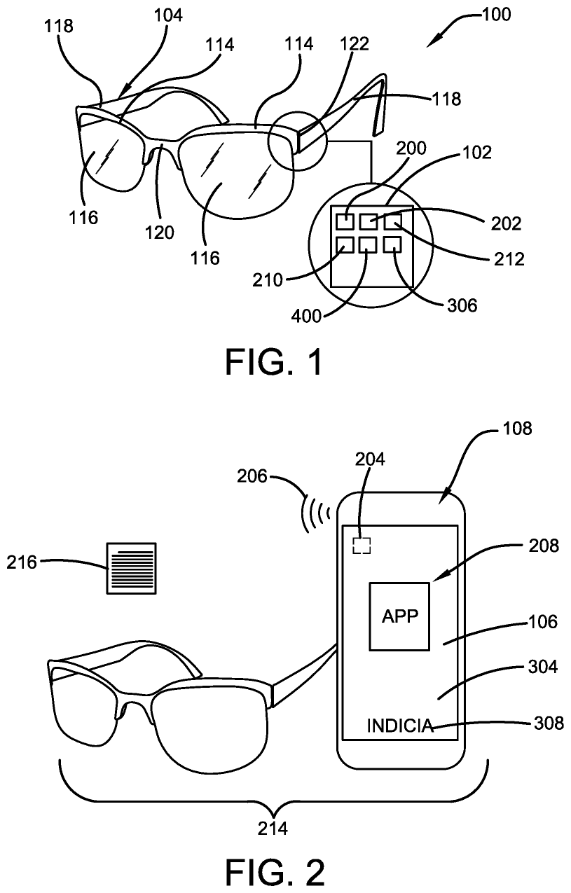

Referring initially to the drawings, FIG. 1 illustrates a perspective view of one embodiment of the frame tracker device 100 of the present invention. In the present embodiment, the frame tracker device 100 is an improved frame tracker device 100 that can identify the location of a user's eyeglass frames 104 via a digital smartphone application 106. Further, the device 100 comprises an integrated tracking unit 102, integrated within a user's eyeglass frames 104, which is used to track the frames 104 via a smartphone application 106. Specifically, the frame tracker device 100 then wirelessly pairs with the smartphone application 106 to identify location of the eyeglass frames 104. Thus, users wirelessly pair their eyeglass frames 104 with the smartphone application 106 downloaded on their smartphone device 108 to view the eyeglass frame's location 110 on a digital map 112.

As discussed above, embodiments of the present disclosure relate to a frame tracker device 100 and more particularly, to an eyeglass tracking system and method used to improve the locating of misplaced eyeglasses 104.

Generally speaking, the frame tracker device 100 provides a tracking system for a pair of eyeglass frames 104. The eyeglass frames 104 can be any suitable shape and size of eyeglass and/or sunglass frames, as is conventionally known in the art. Typically, the eyeglass frames 104 comprise an eye (or lens) receptacle component 114 with lenses 116 and two arm components 118 which secure to either side of the eye receptacle component 114 and rest behind a user's ear during wear. Further, the device 100 is comprised of an embedded or integrated tracking unit 102 that may be placed anywhere within the eyeglass frame 104, such as in the nose frame 120 or temple frame 122, depending on the needs and/or wants of a user 300. Furthermore, the frame tracker device 100 is designed such that the eyeglass frames 104 are still lightweight, despite being equipped with wiring and components associated with the integrated tracking unit 102.

Additionally, the eyeglass frame 104 is preferably an amorphous, amber-to-transparent thermoplastic. The material of the eyeglass frame 104 allows the integrated tracking unit 102 to send transmissions at greater distances, resulting in better connections and more accurate and precise information. The integrated tracking unit 102 works in tandem with a mobile or smartphone computing device application 106 to allow the user 300 to see the location of the eyeglasses 104 on demand. The smartphone application 106 and integrated tracking unit/transmitter 102 may communicate by way of an IEEE 802.15 standard network, GPS, etc., or other suitable technology as is known in the art.

In certain embodiments, the integrated tracking unit/transmitter 102 may be removably sealed within a pair of eyeglass frames 104. Thus, the integrated tracking unit/transmitter 102 may be removed and applied to another set of eyeglass frames 104 in a sealed condition, as needed and/or desired. Thus, a user 300 can utilize the integrated tracking unit 102 for location tracking, with any pair of eyeglasses 104 or sunglasses that they wish.

As shown in FIG. 2, any suitable mobile or smartphone computing device 108 can be used, such as phones, tablets, smartwatches, etc., or any other suitable smart device as is known in the art. Further, the smartphone device 108 is able to continuously store tracking information for the eyeglass frames 104. Additionally, this concept may also be applied to sunglass frames.

Further, the frame tracker device 100 may be beneficial for use by a user 300 to locate missing eyeglasses 104. Specifically, the frame tracker device 100 may include an eyeglass frame 104 with a first concealed low-power, low-duty, low data-rate IEEE 802.15.4/GPS tracking chip/transceiver 102 attached or integrated into the eyeglass frame 104 and configured to transmit a wireless signal, and a mobile or smartphone communications device 108 comprising a processor 200 executing instructions retrieved from a memory 202, a second low-power, low-duty, low data-rate IEEE 802.15.4/GPS tracking chip/transceiver 204 configured to receive the wireless signal 206, and a display device 208.

Furthermore, the first concealed low-power, low-duty, low data-rate IEEE 802.15.4/GPS tracking chip/transceiver 102 is configured to transmit the wireless signal 206 autonomously for months without recharging. When executed, the instructions control the processor 200 to process the wireless signal 206 transmitted/received by the first concealed low-power, low-duty, low data-rate IEEE 802.15.4/GPS tracking chip/transceiver 102 and second low-power, low-duty, low data-rate IEEE 802.15.4/GPS tracking chip/transceiver 204 to create a navigational display 112 (i.e., digital map) on the display device 100, and to cause electronic information determined from the wireless signal 206 by the processor 200 to indicate a geographic location 110 of the eyeglass assembly/frames 104 on the navigational display 112.

In one embodiment, the first concealed low-power, low-duty, low data-rate IEEE 802.15.4/GPS transceiver 102 which is integrated into and concealed by the eyeglass frame 104 comprises a power source 210 and an antenna 212. The first concealed low-power, low-duty, low data-rate IEEE 802.15.4/GPS transceiver 102 continuously transmits electronic location information indicative of geographic location 110 of the eyeglass frames 104 to the smartphone device 108 via the power source 210 and antenna 212. Specifically, the electronic location information determined from the wireless signal 206 by the processor 200 indicates a relative geographic location 110 on the navigational display 112 on the smartphone 108. Further, the electronic location information determined from the wireless signal 206 by the processor 200 indicates an absolute or relative geographic location 110 on the navigational display 112.

In another embodiment, the eyeglass frame 104 may also include an IEEE network standard 802.15 transceiver, an IEEE network standard 802.15.4 transceiver, an IEEE network standard 802.15.4a transceiver, an IEEE network standard 802.11 transceiver, and/or an IEEE network standard 802.16 transceiver, further comprising a battery 210 electrically connected to the transceiver. The integrated tracking unit 102 of the eyeglass frame 104 may also be configured to stay charged for longer periods of time and use less power in comparison to traditional BLUETOOTH technology, which is desirable.

According to one embodiment, the frame tracker device 100 may be arranged as a kit 214. In particular, the frame tracker device 100 may further include a set of instructions 216. The instructions 216 may detail functional relationships in relation to the structure of the frame tracker device 100 (such that the device 100 can be used, maintained, or the like, in a preferred manner).

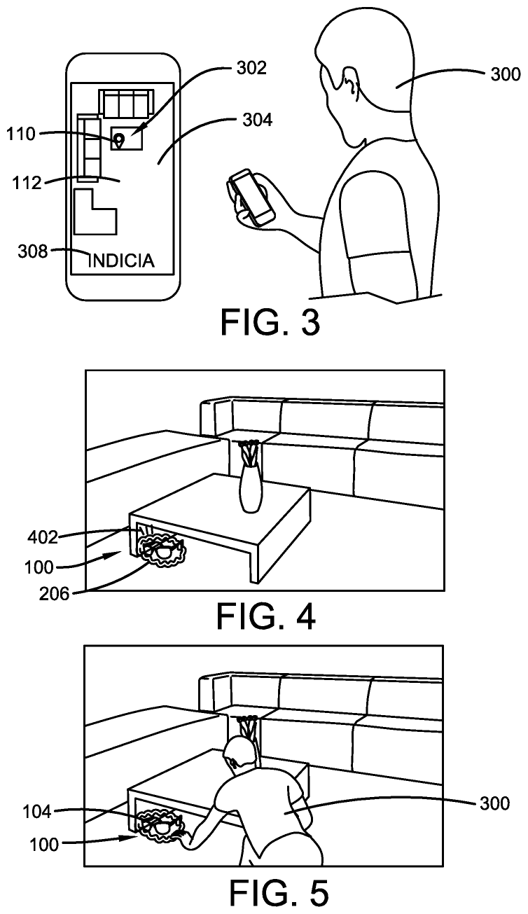

As shown in FIG. 3, the frame tracker device 100 utilizes the smartphone application 106 to place a small marker or drop a pin 302 where the eyeglass frames 104 are located 110, allowing the user 300 to identify the general vicinity in which to locate their eyeglass frames 104.

Further, the frame tracker device 100 further comprises a graphical user interface 304 generated by the instructions of the software application 106; the graphical user interface 304 instructs a user 300 in the direction that indicates the location 110 of the eyeglass frames 104. The eyeglass frames 104 may also include a global positioning system transceiver, a radio frequency identification tag transponder, a BLUETOOTH transceiver, a ZigBee transceiver, or an ultra-wideband transceiver 306, etc., 306 for transmitting signals.

In yet another embodiment, the frame tracker device 100 comprises a plurality of indicia 308. The eyeglass frame 104 of the device 100 may include advertising, trademark, or other letters, designs, or characters, printed, painted, stamped, or integrated into the eyeglass frame 104, or any other indicia 308 as is known in the art. Specifically, any suitable indicia 308 as is known in the art can be included, such as, but not limited to, patterns, logos, emblems, images, symbols, designs, letters, words, characters, animals, advertisements, brands, etc., that may or may not be eyeglass frame, location, or brand related.

As shown in FIGS. 4-5, the electronic communication device (i.e., smartphone) 108 of the frame tracker device 100 and/or the integrated tracking unit 102 comprises a sound generating device 400 which generates an audible alarm or alert 402. Thus, the eyeglasses 104 may also send an alert (audible or otherwise) 402 to the mobile or smartphone device 108 when the user 300 is a preset distance apart from their glasses 104. Further, the electronic location information determined from the wireless signal controls the sound generating device 400 to produce a sound 402 having a volume and frequency that varies with a distance between the eyeglass frame 104 and the electronic communication device (i.e., smartphone) 108. Thus, the audible alarm/alert 402 of the frame tracker device 100 can be triggered by the smartphone application 106 to produce an audible sound 402 from the frames 104 and/or from the smartphone device 108 so that the frames 104 can be easily found. Accordingly, the mobile wireless communications device 108 is wirelessly coupled to the first concealed low-power, low-duty, low data-rate IEEE 802.15.4/GPS transceiver 102 of the eyeglass frame 104. The processor 200 is then configured to receive a signal from the second low-power, low-duty, low data-rate IEEE 802.15.4/GPS transceiver 204 of the smartphone device 108. The signal indicates a direction toward the eyeglass frame 104 relative to the mobile wireless communications device 108.

Accordingly, in use, users 300 would link the integrated tracking unit 102 with their smartphone 108 to conveniently track the eyeglass frame's location 110 on the map 112 on their smartphone 108. The tracking information along with the triggering of the audible alarm/alert 402 allows a user 300 to conveniently and quickly locate their eyeglasses 104 for retrieval to prevent a permanent loss.

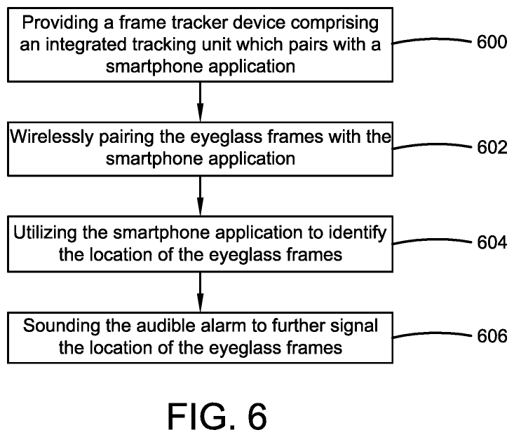

FIG. 6 illustrates a flowchart of the method of tracking a user's eyeglass frames to identify the location on a smartphone. The method includes the steps of at 600, providing a frame tracker device comprising an integrated tracking unit which pairs with a smartphone application. The method also comprises at 602, wirelessly pairing the eyeglass frames with the smartphone application. Further, the method comprises at 604, utilizing the smartphone application to identify the location of the eyeglass frames. Finally, the method comprises at 606, sounding the audible alarm to further signal the location of the eyeglass frames.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “frame tracker device”, “frame device”, “tracker device”, and “device” are interchangeable and refer to the frame tracker device 100 of the present invention.

Notwithstanding the foregoing, the frame tracker device 100 of the present invention can be of any suitable size and configuration as is known in the art without affecting the overall concept of the invention, provided that it accomplishes the above-stated objectives. One of ordinary skill in the art will appreciate that the frame tracker device 100 as shown in FIGS. 1-6 are for illustrative purposes only, and that many other sizes and shapes of the frame tracker device 100 are well within the scope of the present disclosure. Although the dimensions of the frame tracker device 100 are important design parameters for user convenience, the frame tracker device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A frame tracker device that electronically identifies location of a user's eyeglass frame, the frame tracker device comprising:
an eyeglass frame; and
an integrated tracking unit;
wherein the integrated tracking unit is integrated within the eyeglass frame during use;
wherein the integrated tracking unit is used to track the eyeglass frame via a smartphone application; and
further wherein the frame tracker device wirelessly pairs with a smartphone device to identify location of the eyeglass frame.

2. The frame tracker device of claim 1, wherein the smartphone application is downloaded on the smartphone device.

3. The frame tracker device of claim 2, wherein the smartphone device comprises a digital map for viewing location of the eyeglass frame.

4. The frame tracker device of claim 3, wherein the eyeglass frame is a sunglass frame.

5. The frame tracker device of claim 4, wherein the eyeglass frame comprises an eye receptacle component with lenses and two arm components which secure to either side of the eye receptacle component and rest behind a user's ear during use.

6. The frame tracker device of claim 5, wherein the integrated tracking unit is placed in a nose frame or a temple frame.

7. The frame tracker device of claim 6, wherein the integrated tracking unit works in tandem with the smartphone application to allow the user to see the location of the eyeglass frame on demand.

8. The frame tracker device of claim 7, wherein the integrated tracking unit is a transmitter that may communicate by way of an IEEE 802.15 standard network or a GPS.

9. The frame tracker device of claim 8, wherein the integrated tracking unit and transmitter may be removably sealed within the eyeglass frame to allow the user to remove and apply the frame tracker device to another eyeglass frame.

10. The frame tracker device of claim 9, wherein the integrated tracking unit and transmitter are configured to transmit a wireless signal, and the smartphone device comprises a processor executing a set of instructions retrieved from a memory, a second transceiver configured to receive the wireless signal, and a display device.

11. The frame tracker device of claim 10, wherein the set of instructions control the processor to process the wireless signal transmitted and received by a first transceiver and the second transceiver to create a digital map on a display of the smartphone device, and to cause electronic information determined from the wireless signal by the processor to indicate a geographic location of the eyeglass frame on the digital map.

12. The frame tracker device of claim 11, wherein the first transceiver is integrated into and concealed by the eyeglass frame and comprises a power source and an antenna.

13. The frame tracker device of claim 12, wherein the frame tracker device utilizes the smartphone application to place a small marker or drop a pin where the eyeglass frame is located, allowing the user to identify the a general vicinity in which to locate the eyeglass frame.

14. The frame tracker device of claim 13 further comprising a sound generating device, which generates an audible alert that varies with a distance between the eyeglass frame and the smartphone device.

15. A frame tracker device that electronically identifies a location of a user's eyeglass frame, the frame tracker device comprising:
an eyeglass frame; and
an integrated tracking unit;
wherein the integrated tracking unit is integrated within the eyeglass frame during use;
wherein the integrated tracking unit is used to track the eyeglass frame via a smartphone application;
wherein the smartphone application is downloaded on the smartphone device; and
wherein the frame tracker device wirelessly pairs with a smartphone device to identify location of the eyeglass frame;
wherein the smartphone device comprises a digital map for viewing location of the eyeglass frame;
wherein the integrated tracking unit is placed anywhere within the eyeglass frame;
wherein the smartphone device comprises a graphical user interface generated by the instructions of the smartphone application; and
further wherein the smartphone device comprises a sound generating device, which generates an audible alert that varies with a distance between the eyeglass frame and the smartphone device.

16. The frame tracker device of claim 15 wherein the integrated tracking unit is a transmitter that may communicate by way of an IEEE 802.15 standard network or GPS.

17. The frame tracker device of claim 16 wherein the integrated tracking unit and transmitter are configured to transmit a wireless signal, and the smartphone device comprises a processor executing instructions retrieved from a memory, a second transceiver configured to receive the wireless signal, and a display device.

18. The frame tracker device of claim 17 wherein instructions control the processor to process the wireless signal transmitted and received by a first transceiver and the second transceiver to create a digital map on a display of the smartphone device, and to cause electronic information determined from the wireless signal by the processor to indicate a geographic location of the eyeglass frames on the digital map.

19. The frame tracker device of claim 15 further comprising a plurality of indicia.

20. A method of tracking a user's eyeglass frame to identify location on a smartphone, the method comprising the following steps:
providing a frame tracker device comprising an integrated tracking unit which pairs with a smartphone application;
wirelessly pairing the eyeglass frame with the smartphone application;
utilizing the smartphone application to identify the location of the eyeglass frame; and
sounding the audible alarm to further signal the location of the eyeglass frame.
